(19) United States
(12) Patent Application Publication
(10) Pub. No.: US 2013/0104861 A1
(43) Pub. Date: May 2, 2013

(54) Enhanced Combustion for Compression Ignition Engine Using Electromagnetic Energy Coupling

(71) Applicants: Charles E. Roberts, JR., Helotes, TX (US); Jess W. Gingrich, San Antonio, TX (US); Terrence F. Alger, II, San Antonio, TX (US)

(72) Inventors: Charles E. Roberts, JR., Helotes, TX (US); Jess W. Gingrich, San Antonio, TX (US); Terrence F. Alger, II, San Antonio, TX (US)

(73) Assignee: SOUTHWEST RESEARCH INSTITUTE, San Antonio, TX (US)

(21) Appl. No.: 13/283,098

(22) Filed: Oct. 27, 2011

(51) Int. Cl. F02P 1/00

(52) U.S. Cl. 123/594

(57) ABSTRACT

A method of improving the diffusion combustion of a compression ignition engine. Such engines have at least one cylinder, each cylinder having a compression chamber and operated with an intake phase, compression phase, expansion phase, and exhaust phase of a reciprocating piston. An antenna is placed within the combustion chamber, and is used to apply electromagnetic energy to the diffusion combustion.

### TECHNICAL FIELD OF THE INVENTION

This invention relates to internal combustion engines, and more particularly to enhancing combustion for such engines when operated with compression ignition.

### BACKGROUND OF THE INVENTION

Today's diesel engines must meet strict emissions requirements while also providing high fuel efficiency. To achieve these goals, many diesel engines use various combustion strategies, which nevertheless result in emissions of particulate matter, unburned hydrocarbons and carbon monoxide.

All of these types of emissions can be considered to be partially-oxidized emissions that could be reduced if oxidation were enhanced. Also, if oxidation of these emissions could be enhanced, total energy released during the combustion process would increase, thereby improving the engine's combustion efficiency.

### BRIEF DESCRIPTION OF THE DRAWINGS

A more complete understanding of the present embodiments and advantages thereof may be acquired by referring to the following description taken in conjunction with the accompanying drawings, in which like reference numbers indicate like features, and wherein:

FIG. 1 illustrates a cylinder of a compression ignition engine during the expansion phase of operation, the piston having an antenna for application of electromagnetic energy.

FIG. 2 illustrates how the antenna may be alternatively placed on the cylinder fire deck.

FIG. 3 illustrates how the antenna may be placed on a valve.

### DETAILED DESCRIPTION OF THE INVENTION

The following description is directed to methods of enhancing combustion in a compression ignition engine, using electromagnetic radiation. A microwave emitter (antenna) is placed within the combustion chamber and irradiates the air-fuel mixture (including any diluents such as EGR) in the chamber. The application of electromagnetic energy to the combustion gases enhances oxidation of emissions.

The microwave region of the electromagnetic spectrum is of primary interest due to its inherent ability to interact directly with plasma. Microwave generation, transmission and other related system components are in use in other industries and can be adapted for use in this application.

Electromagnetic energy can be coupled to the diffusion combustion flame front due to the existence of combustion ions in this region. Oxidation of fuel and combustion gases is improved. Adding energy to the flame front in the form of an alternating current electric field can enhance reaction rates with a net result of faster flame speeds and more complete combustion. The combination of dilute engine operation and application of electromagnetic energy to the combustion process can also result in reduced pollutants.

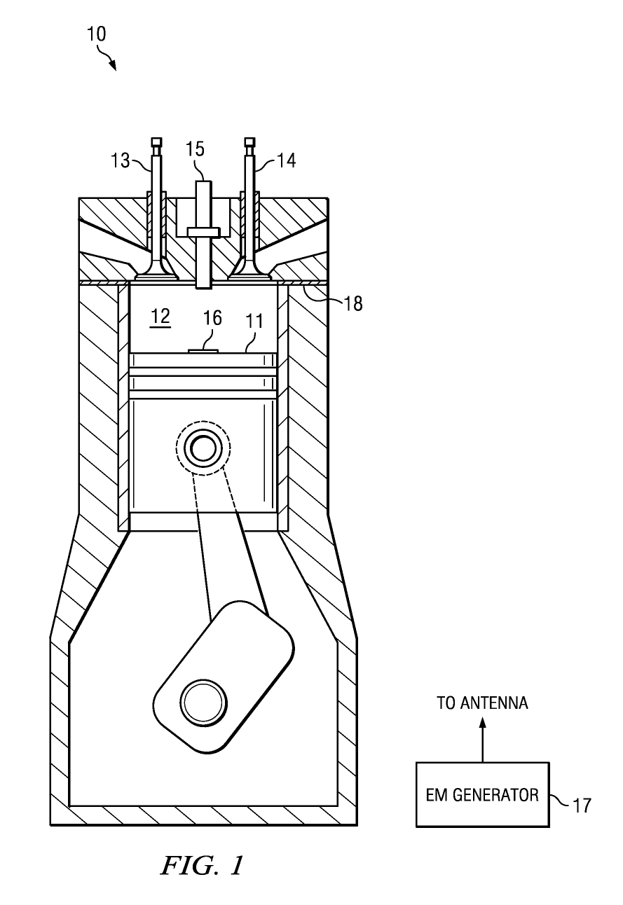

FIG. 1 illustrates a typical engine cylinder 10 of a compression ignition internal combustion engine, the cylinder 10 having a piston 11 and related components. Such engines operate on a four-stroke working principle. In a four-stroke engine, the piston 11 undergoes intake, compression, expansion, and exhaust strokes, with air intake and fuel injection occurring during the intake and compression strokes, respectively. Diffusion combustion occurs during the expansion stroke.

With relevance to this description, FIG. 1 illustrates the components that bound the volume of the combustion chamber 12. The piston 11 is shown during it expansion stroke, with diffusion combustion occurring in the combustion chamber 12. The intake valve 13 and exhaust valve 14 are closed, which fully isolates the combustion volume. The fuel injector 15 has delivered fuel into the chamber during the previous (compression) stroke. The top of piston 11 closes against a fire deck 18 below the valves.

The inner wall of the combustion chamber 12 is nearly fully reflective to microwave radiation. This permits electromagnetic energy to be concentrated inside the combustion chamber 12 before and during the combustion process.

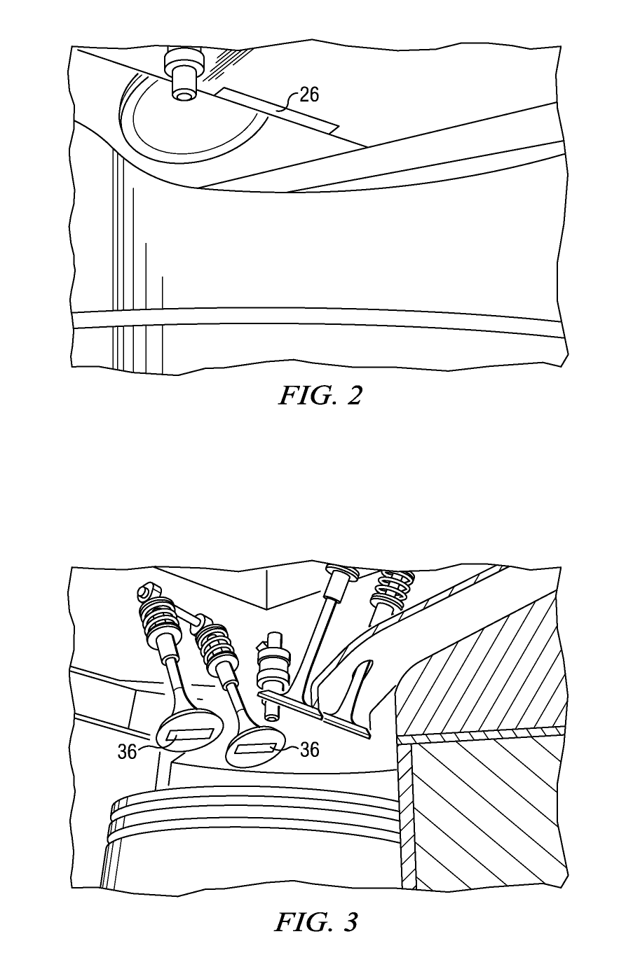

For implementation of the above-described method, an antenna 16 is placed in the combustion chamber 12 to transmit the electromagnetic energy. In the embodiment of FIG. 1, antenna 16 is embedded into the top of piston 11 such that its field radiates outward from the top of the piston 11. Antenna 16 is electrically isolated from the surrounding material of the top of the piston. As explained below in connection with FIGS. 2 and 3, in other embodiments, the antenna 16 may be placed in other locations in the combustion chamber 12.

Electromagnetic generator 17 is in electrical connection with the antenna 16, and located outside the combustion chamber 12. It can be a fixed frequency generator, such as a magnetron that converts electricity into microwave energy. During or just after the diffusion combustion event, it provides a burst or continuous output of electromagnetic energy to antenna 16.

As explained below, in more sophisticated embodiments, electromagnetic generator 17 may be capable of generating electromagnetic energy at more than one frequency. Devices and methods for generating and transmitting microwave energy can include devices and methods that are known or to be developed in the field of consumer appliances and communications.

The internal geometry of the combustion chamber 12 can be designed to match the characteristic lengths of radiation from antenna 16 in three-dimensional space. In this manner, regions of superposition with intense field strength can be created. The combustion chamber 12 can act as a resonant cavity for electromagnetic energy. Its geometry can be further tuned so that the regions of high intensity are located where the enhanced flame will be most beneficial to overall combustion.

Also, the electromagnetic frequency can be tuned to the combustion chamber 12. More specifically, the frequency of the electromagnetic radiation from generator 17 can be tuned to match the changing distance between the antenna 16 and the primary reflecting surface. For example, if the antenna 16 is in the top of piston 11, the frequency can be tuned for the distance to the intake valve or cylinder head. As the combustion chamber's dimensions change during the compression and expansion strokes, the electromagnetic energy can be adjusted to maintain constructive interference (resonance) at the regions of importance for combustion enhancement.

The electromagnetic energy can be continuous or pulsed. Electromagnetic generator 17 can include a control unit, hardwired or programmed, to tune, phase, and modulate the electromagnetic energy throughout the combustion period where the flame is growing. The microwave energy may be delivered to the flame as it is combusting or to post-combustion gases, or both. As the flame grows, the resonance nodes at different locations in the combustion chamber may be desired, and generator 17 can be programmed or electrically designed to tune frequency accordingly.

FIGS. 2 and 3 illustrate alternative locations of the antenna. Antennas 26 and 36 are located on the cylinder's fire deck or valve, respectively. In the example of FIG. 3, the antenna 36 is embedded in the bottom of the plug (disk-shaped) portion of the valve.

As indicated above, the antenna may be located anywhere inside the combustion chamber that best suits the combustion chamber geometry. For purposes of this description, the antenna may be on or integrated with various surfaces internal to the combustion chamber, regardless of the method of attachment of the antenna, by embedding or affixing or otherwise. It may also be desirable to use more than one antenna.

The application of electromagnetic energy to the combustion process results in improved energy conversion efficiency, thus improving fuel efficiency. An additional result is that emissions of harmful pollutants, such as unburned hydrocarbons, are reduced. Chemical reactions of other types may also be favorably promoted to reduce emissions and maximize combustion energy release.

What is claimed is:

1. A method of improving the diffusion combustion of a compression ignition engine, the engine having at least one cylinder, each cylinder having a combustion chamber and operated with an intake phase, compression phase, expansion phase, and exhaust phase of a piston, the method comprising:
locating an antenna within the combustion chamber;
providing air into the combustion chamber during the intake phase;
providing fuel into the combustion chamber during the compression phase;
delivering an electromagnetic signal to the antenna;
wherein the antenna applies electromagnetic energy to the diffusion combustion during the expansion phase.

2. The method of claim 1, wherein the electromagnetic signal is a microwave signal.

3. The method of claim 1, wherein the electromagnetic signal is pulsed.

4. The method of claim 1, wherein the microwave signal is continuous.

5. The method of claim 1, wherein the locating step is performed by locating the antenna at the top of the piston.

6. The method of claim 1, wherein each cylinder has at least one intake or exhaust valve and wherein the locating step is performed by locating the antenna on a valve.

7. The method of claim 1, wherein each cylinder has a firing deck and wherein the locating step is performed by locating the antenna on the firing deck.

8. The method of claim 1, further comprising the step of controlling the frequency of the electromagnetic signal to in response to the changing internal geometry of the combustion chamber during the expansion stroke.

9. A piston cylinder for use in a compression ignition engine to be operated with an intake phase, compression phase, expansion phase, and exhaust phase, comprising:
a combustion chamber;
a piston operable to move reciprocally within the combustion chamber;
at least one intake valve;
at least one exhaust valve;
an antenna located within the combustion chamber;
an electromagnetic generator located outside the combustion chamber, in electrical connection with the antenna, and operable to deliver an electromagnetic signal to the antenna;
wherein the antenna is operable to radiate electromagnetic energy into the combustion chamber during the expansion phase.

10. The cylinder of claim 9, wherein the electromagnetic signal is a microwave signal.

11. The cylinder of claim 9, wherein the electromagnetic signal is pulsed.

12. The cylinder of claim 9, wherein the microwave signal is continuous.

13. The cylinder of claim 9, wherein the antenna is located at the top of the piston.

14. The cylinder of claim 9, wherein each cylinder has at least one intake or exhaust valve and wherein the antenna is located on a valve.

15. The cylinder of claim 9, wherein each cylinder has a firing deck and wherein the antenna is located on the firing deck.

16. The cylinder of claim 9, wherein the electromagnetic generator is programmed to control the frequency of the electromagnetic signal to in response to changing internal geometry of the combustion chamber during the expansion stroke.
